(19) United States
(12) Patent Application Publication
(10) Pub. No.: US 2026/0103593 A1
(43) Pub. Date: Apr. 16, 2026

(54) RESIN MOLDING MATERIAL AND METHOD FOR RECYCLING THERMOSETTING URETHANE

(71) Applicant: KASAI KOGYO CO., LTD., Kanagawa (JP)

(72) Inventors: Toyokazu ENDO, Samukawa-machi (JP); Shinnosuke OKADA, Ebina-shi (JP)

(21) Appl. No.: 19/422,824

(22) Filed: Dec. 17, 2025

Related U.S. Application Data
(63) Continuation of application No. PCT/JP2023/031819, filed on Aug. 31, 2023.

(51) Int. Cl. C08L 75/00; B29B 9/06; B29B 17/04; B29K 23/00; B29K 67/00; B29K 75/00; B29K 105/26; B29K 309/08; B29K 421/00; B29K 509/00; B29L 9/00; C08K 3/34; C08K 7/14; C08L 23/12; C08L 67/02

(52) U.S. Cl. CPC C08L 75/00; B29B 9/06; B29B 17/0412; C08K 3/34; C08K 7/14; C08L 23/12; C08L 67/02; B29K 2023/12; B29K 2067/003; B29K 2075/00; B29K 2105/26; B29K 2309/08; B29K 2421/00; B29K 2509/00; B29K 2995/0089; B29L 2009/00; C08L 2207/20

(57) ABSTRACT

A resin molding material includes (A) a recycled material and (B) a thermoplastic resin. The recycled material is a mixture including thermosetting urethane, short glass fibers, and polyethylene terephthalate. The recycled material and the thermoplastic resin are mixed with each other such that the recycled material accounts for 5% to 60% by weight and the thermoplastic resin accounts for 40% to 95% by weight, and a total amount of (A) and (B) is 100% by weight.

### CROSS-REFERENCE TO RELATED APPLICATIONS

This application is a continuation application of PCT International Application No. PCT/JP2023/031819, filed on Aug. 31, 2023, the entire contents of which are hereby incorporated by reference.

### BACKGROUND

### 1. Technical Field

The present invention relates to a resin molding material, and a method for recycling thermosetting urethane.

### 2. Description of the Background

Japanese Patent Application Laid-Open Publication No. 2003-012759 (hereinafter referred to as Patent Literature 1) describes a recycling method for reusing rigid urethane foam that has been produced from a raw material including diphenylmethane diisocyanate as an essential component. This recycling method includes a regeneration step, an addition polymerization step, and a foaming step. At the regeneration step, a polyurethane raw material is regenerated from the rigid urethane foam. At the addition polymerization step, alkylene oxide is addition-polymerized to the polyurethane raw material to produce polyol. At the foaming step, isocyanate and other auxiliary agents are added to the polyol to regenerate the rigid polyurethane foam.

### BRIEF SUMMARY

Thermosetting urethane does not melt even when heated. For this reason, a step (chemical recycling) is needed as in the recycling method of Patent Literature 1. At the chemical recycling, the thermosetting urethane is chemically treated to be returned into a urethane raw material.

However, the chemical recycling requires large-scale equipment. Accordingly, the cost of the recycling becomes high, and thus hinders the practical implementation. Although urethane alone can be recycled by the chemical recycling, it is difficult to reproduce a urethane composite material.

In view of the above, an object of the present invention is to recycle a composite material including thermosetting urethane, with relatively simple equipment.

In order to achieve the above-described object, a first aspect of the present invention provides a resin molding material including (A) a recycled material and (B) a thermoplastic resin. The recycled material is a mixture including thermosetting urethane, short glass fibers, and polyethylene terephthalate. The recycled material and the thermoplastic resin are mixed with each other such that the recycled material accounts for 5% to 60% by weight and the thermoplastic resin accounts for 40% to 95% by weight, and a total amount of (A) and (B) is 100% by weight.

A second aspect of the present invention provides a resin molding material including (A) a recycled material, (B) a thermoplastic resin, and (C) an additive. The recycled material is a mixture including thermosetting urethane, short glass fibers, and polyethylene terephthalate. The recycled material and the additive are mixed with the thermoplastic resin such that the recycled material accounts for 5% to 60% by weight, the additive accounts for 0% to 30% by weight (excluding 0% by weight), and the thermoplastic resin accounts for 10% to 95% by weight, and a total amount of (A), (B), and (C) is 100% by weight.

A third aspect of the present invention provides a method for recycling thermosetting urethane. The method includes a recycled material production step and a resin molding material production step. At the recycled material production step, a composite material including the thermosetting urethane, glass fibers, and polyethylene terephthalate is pulverized into particles so as to produce a recycled material that is a mixture including the thermosetting urethane, the shortened glass fibers, and the polyethylene terephthalate. At the resin molding material production step, the recycled material is mixed with a thermoplastic resin so as to produce a resin molding material.

The resin molding materials according to the first and second aspects and the resin molding material produced at the resin molding material production step in the third aspect may each include 1.5% to 29% by weight of the thermosetting urethane, 1.15% to 24.6% by weight of the short glass fibers, and 1.0% to 13.8% by weight of the polyethylene terephthalate.

According to the present invention, a composite material including thermosetting urethane can be recycled with relatively simple equipment.

### BRIEF DESCRIPTION OF DRAWINGS

FIG. 1 illustrates a recycled material production step according to a first embodiment of the present invention.

FIG. 2 illustrates a resin molding material production step according to the first embodiment of the present invention.

FIG. 3 schematically illustrates a configuration example of a composite material.

FIG. 4 illustrates an example in which a resin molding material is used in injection molding.

FIG. 5 represents one example of a relation between a mixing ratio of a recycled material and a density of a resin molded product.

FIG. 6 represents one example of a relation between the mixing ratio of the recycled material and a heat deflection temperature of the resin molded product under load.

FIG. 7 represents one example of a relation between the mixing ratio of the recycled material and a flexural modulus of the resin molded product.

FIG. 8 represents one example of a relation between the mixing ratio of the recycled material and flexural strength of the resin molded product.

FIG. 9 represents one example of a relation between the mixing ratio of the recycled material and tensile elongation of the resin molded product at break.

FIG. 10 represents one example of a relation between the mixing ratio of the recycled material and tensile stress of the resin molded product at yield.

FIG. 11 represents one example of a relation between the mixing ratio of the recycled material and an Izod impact value (23° C.) of the resin molded product.

FIG. 12 represents one example of a relation between the mixing ratio of the recycled material and an Izod impact value (−30° C.) of the resin molded product.

FIG. 13 illustrates a resin molding material production step according to a second embodiment of the present invention.

### DETAILED DESCRIPTION

### First Embodiment

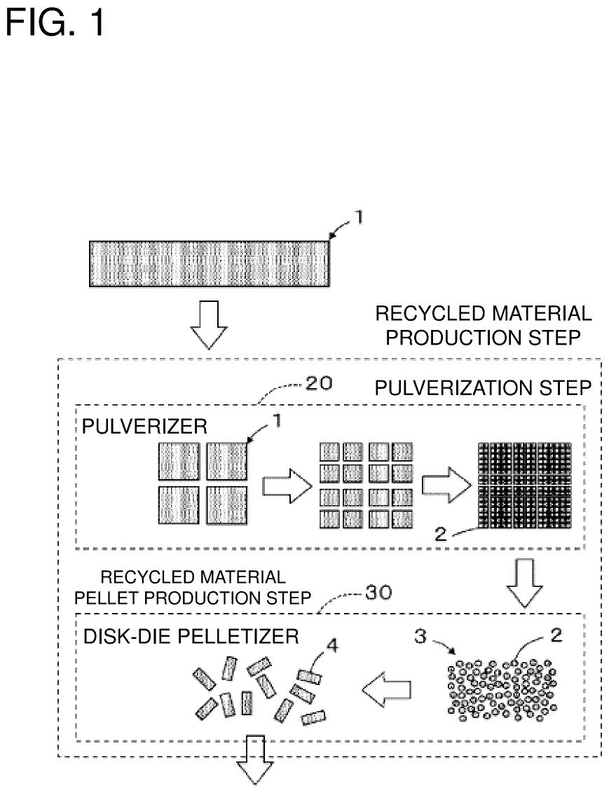

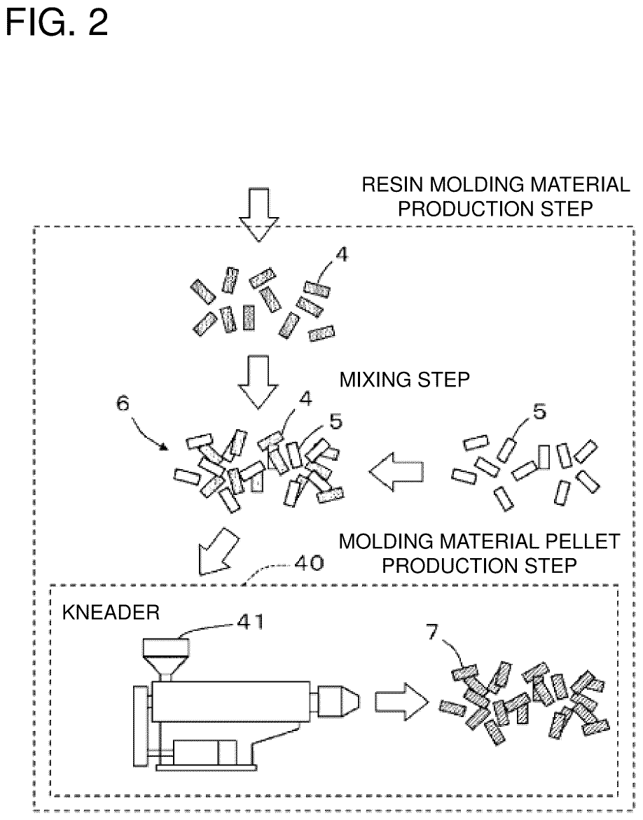

The following describes a first embodiment of the present invention with reference to the drawings. A recycling method according to the present embodiment includes a recycled material production step (refer to FIG. 1) and a resin molding material production step (refer to FIG. 2).

A composite material 1 as a recycling target includes thermosetting urethane, glass fibers, and polyethylene terephthalate (PET). In a described case in the present embodiment, edge offcuts (ceiling edge offcuts) of a urethane ceiling are recycled. The urethane ceiling forms a ceiling interior of an automobile. The recycling target is not limited to the ceiling edge offcuts of the automobile, and may be any composite material 1 that includes thermosetting urethane, glass fibers, and PET.

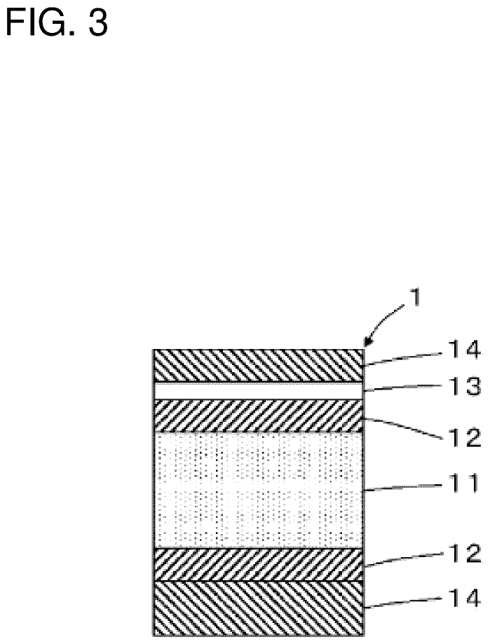

As illustrated in FIG. 3, the composite material 1 in the present embodiment is a member that includes a plurality of layers (six layers in the illustrated example). A plurality of the layers are superimposed one on another in an up-down direction, and are bonded together to be integrated with each other. A plurality of the layers include a urethane layer 11, upper and lower glass mat layers 12, a film layer 13, and upper and lower surface layers 14. The upper and lower glass mat layers 12 are superimposed on upper and lower surfaces of the urethane layer 11. The film layer 13 is superimposed on an upper surface of the upper glass mat layer 12. The upper surface layer 14 is superimposed on an upper surface of the film layer 13. The lower surface layer 14 is superimposed on a lower surface of the lower glass mat layer 12.

The urethane layer 11 is made of semi-rigid urethane foam (thermosetting urethane). The glass mat layers 12 are each made of glass fibers (long glass fibers) and isocyanate. The film layer 13 is made of a cast polypropylene (CPP, i.e., non-stretched polypropylene) film and a polypropylene (PP) film. The surface layer 14 is made of non-woven fabric or cloth. The non-woven fabric and the cloth are each constituted by PET fibers. In other words, the thermosetting urethane among the constituents of the composite material 1 is included in the urethane layer 11. The glass fibers among the constituents of the composite material 1 are included in the glass mat layers 12. The PET among the constituents of the composite material 1 is included as the PET fibers in the surface layer 14.

The content of each constituent in the composite material 1 is as follows, for example. The composite material 1 includes 30% to 49% by weight of the thermosetting urethane, 23% to 41% by weight of the glass fibers, 20% to 23% by weight of the PET, and 6% to 11% by weight of the other constituents (the total amount of the thermosetting urethane, the glass fibers, the PET, and the other constituents is 100% by weight). The other constituents include the CPP film and the PP film of the film layer 13 and an adhesive used for bonding the layers to each other.

As illustrated in FIG. 1, the recycled material production step includes a pulverization step and a recycled material pellet production step.

At the pulverization step, the composite material 1 including the thermosetting urethane, the glass fibers, and the PET is pulverized into particles so that a recycled material 3 is produced. The recycled material 3 is a mixture including the thermosetting urethane, the shortened glass fibers, and the PET. In the present embodiment, the composite material 1 is fed into a pulverizer 20 and thereby pulverized into particles having diameters of approximately 5 mm. Thus, the recycled material 3 is produced as the mixed particles. The recycled material 3 is a collection of the particles (composite material particles) 2 of the composite material 1 that has been pulverized into the particle form. Each of the composite material particles 2 includes at least one of the constituents of the composite material 1. The recycled material 3 as a whole includes all of the constituents of the composite material 1. The long glass fibers of the composite material 1 are included in the composite particles 2 in a state where the long glass fibers are pulverized and thereby cut into the shortened fibers (short glass fibers) having lengths of approximately 1 mm to 6 mm.

At the recycled material pellet production step, the recycled material 3 is processed into recycled material pellets 4. In the present embodiment, the recycled material 3 is fed into a disk-die pelletizer 30 and thereby compressed into the pellets. In this manner, these recycled material pellets 4 are produced.

The recycled material 3 (composite material particles 2) in the particle form is sufficiently mixed and processed into the recycled pellets 4. As a result, a ratio of the content of each constituent in the single recycling pellet 4 can be made closer to a ratio of the content of the constituent in the composite material 1. Since the recycled material 3 in the particle form is processed into the recycled material pellets 4, the recycled material 3 can be easily stored and supplied to the next step (resin molding material production step).

As illustrated in FIG. 2, the resin molding material production step includes a mixing step and a molding material pellet production step.

At the mixing step, the recycled material 3 (refer to FIG. 1) is mixed with a thermoplastic resin so that a resin molding material 6 is produced. In the present embodiment, the recycled material pellets 4 produced at the recycled material pellet production step are mixed with base resin pellets 5 at a predetermined mixing ratio so that the resin molding material 6 is produced. The base resin pellets 5 are pellets into which a base resin made of a thermoplastic resin has been processed. The resin molding material 6 is a mixture of the solid recycled material 3 and the solid base resin at a predetermined mixing ratio. The resin molding material 6 in the present embodiment is a collection of two kinds of the pellets that are the recycled material pellets 4 and the base resin pellets 5 mixed with each other at a predetermined mixing ratio.

The mixing ratio of the recycled material 3 (recycled material pellets 4) and the base resin (base resin pellets 5) is set such that the recycled material 3 accounts for 5% to 60% by weight, and the base resin accounts for 40% to 95% by weight (the total amount of the recycled material 3 and the base resin is 100% by weight).

In the described case in the present embodiment, the polypropylene (PP) is used as the base resin. However, any of other thermoplastic resins (e.g., acrylonitrile butadiene styrene resin (ABS resin)) may also be used as the base resin. A shape of the base resin is not limited to a pellet shape, and may be any of other shapes. The base resin may be a virgin material or a recycled material.

At the molding material pellet production step, the resin molding material 6 is processed into molding material pellets 7. In the present embodiment, the resin molding material 6 is fed into a hopper 41 of a kneader (twin-screw extruder) 40. Thereby, the recycled material 3 (recycled material pellets 4) and the base resin (base resin pellets 5) are kneaded together and compressed into pellets. In this manner, these molding material pellets 7 are produced. Processing the resin molding material 6 into the molding material pellets 7 can stabilize the mixing ratio between the recycled material 3 and the base resin.

The content of each of the base resin (PP), the thermosetting urethane, the short glass fibers, the PET, and the other constituents in the resin molding material 6 (molding material pellets 7) is preferably set such that the base resin accounts for 10% to 95% by weight, the thermosetting urethane accounts for 1.5% to 29% by weight, the short glass fibers accounts for 1.15% to 24.6% by weight, the PET accounts for 1.0% to 13.8% by weight, and the other constituents account for 0.3% to 6.6% by weight (the total amount of the base resin, the thermosetting urethane, the short glass fibers, the PET, and the other constituents is 100% by weight).

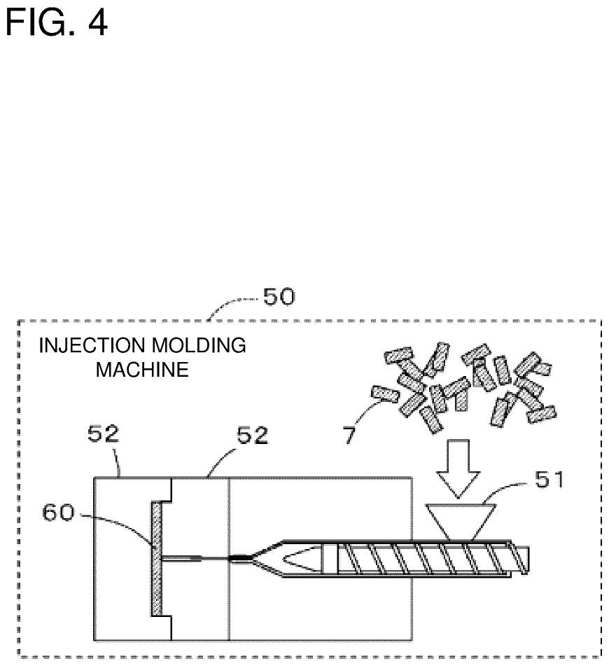

The molding material pellets 7 produced at the resin molding material production step can be used in manufacturing a resin molded product 60 by injection molding, extrusion molding, press molding, or the like. For example, in the case of the injection molding, as illustrated in FIG. 4, the molding material pellets 7 are fed into a hopper 51 in an injection molding machine 50. Next, in the injection molding machine 50, the molding material pellets 7 are heated and thereby melted, and injected into a mold 52 to be then cooled and solidified. As a result, the resin molded product 60 is formed. The resin molded product 60 is then taken out from the mold 52.

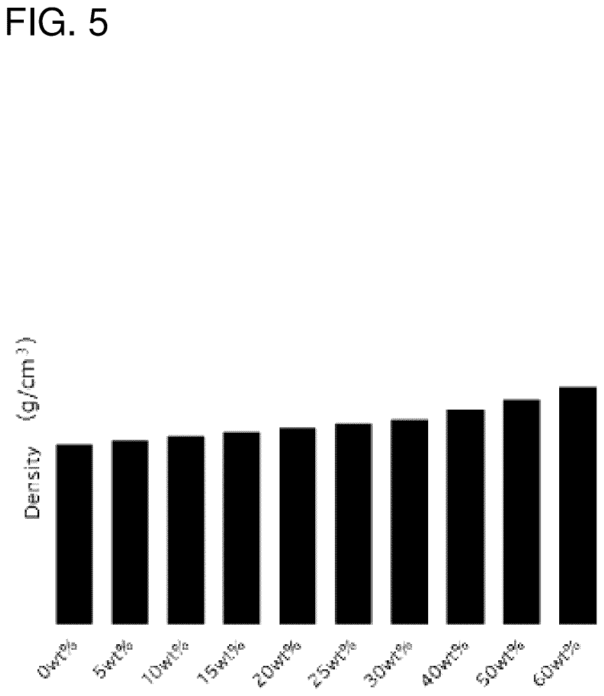

Next, a relation between physical properties of the resin molded product 60 and the mixing ratio (weight percentage) of the recycled material 3 in the resin molding material 6 is described with reference to FIG. 5 to FIG. 12. The resin molded product 60 is manufactured using the resin molding material 6 (molding material pellets 7) according to the present embodiment. FIG. 5 to FIG. 12 represent one example of a comparison result concerning the physical properties of ten kinds of the resin molded products 60. In this case, the base resin is the PP. Ten kinds of the resin molding materials 6 were produced so as to have the respective mixing ratios of the recycled material 3 increased from 0 weight percent to 30 weight percent in increments of 5 weight percent and increased from 30 weight percent to 60 weight percent in increments of 10 weight percent. Each of these resin molding materials 6 was injection-molded to manufacture the corresponding resin molded product 60. In each of these drawings, the horizontal axis indicates the mixing ratio of the recycled material 3, and the vertical axis indicates a value of the physical property.

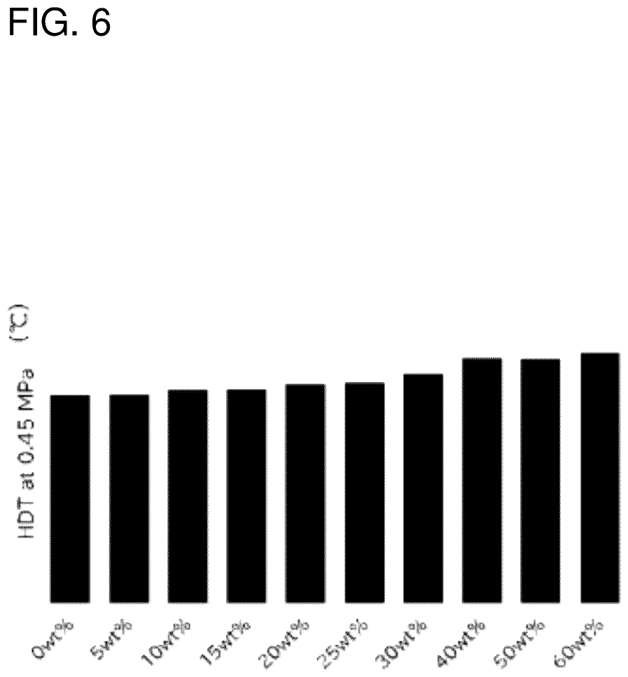

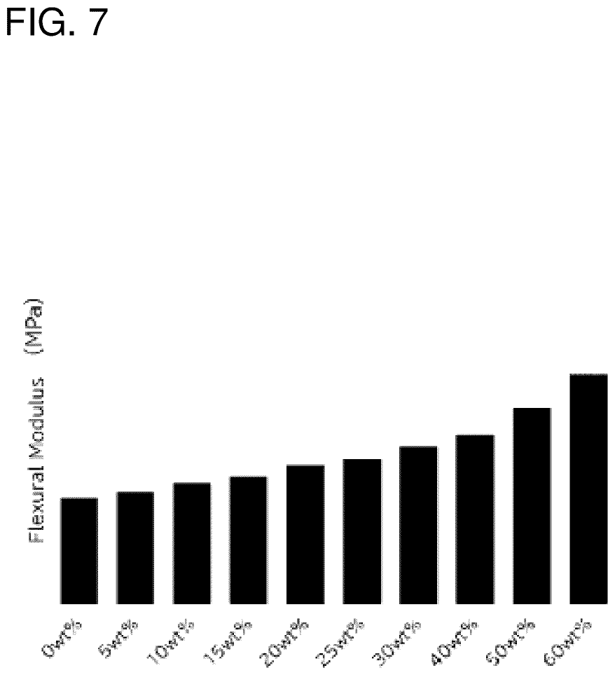

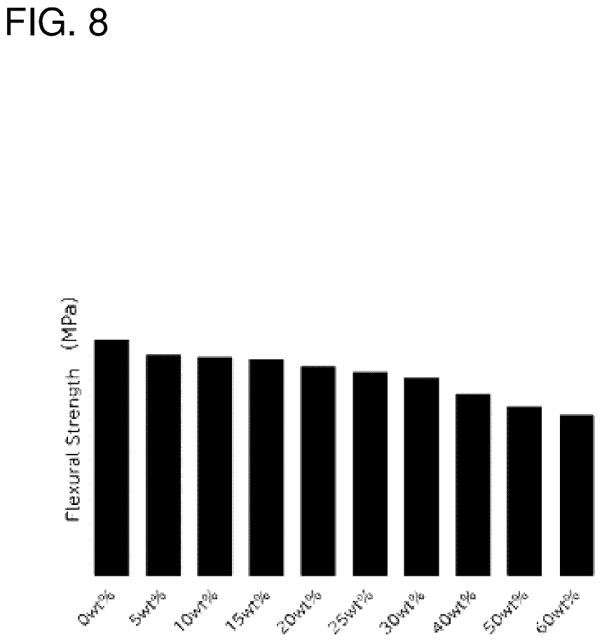

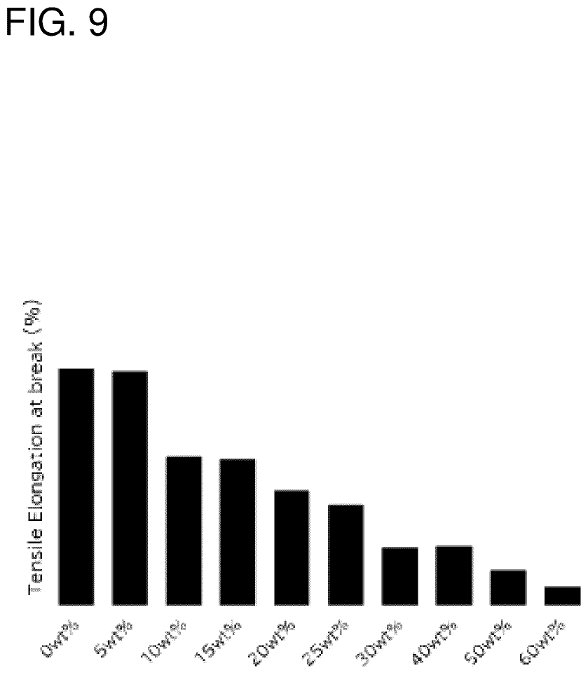

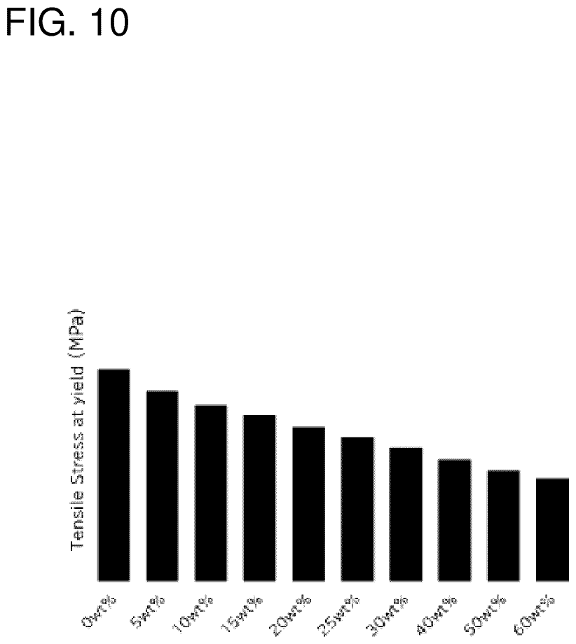

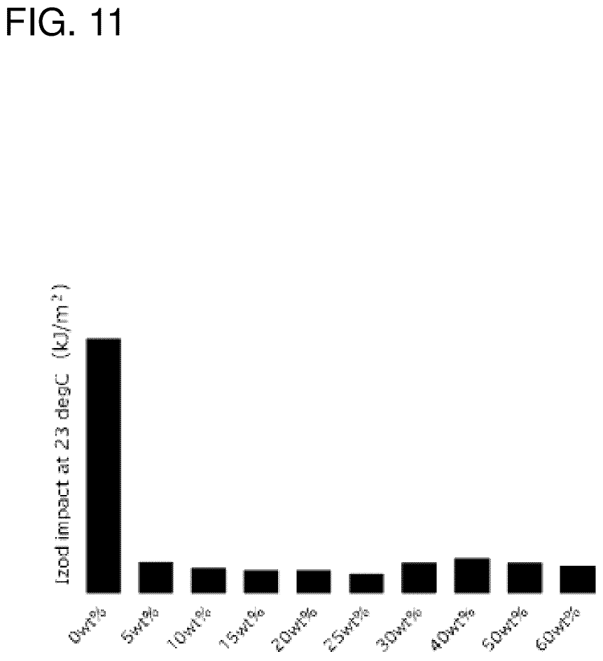

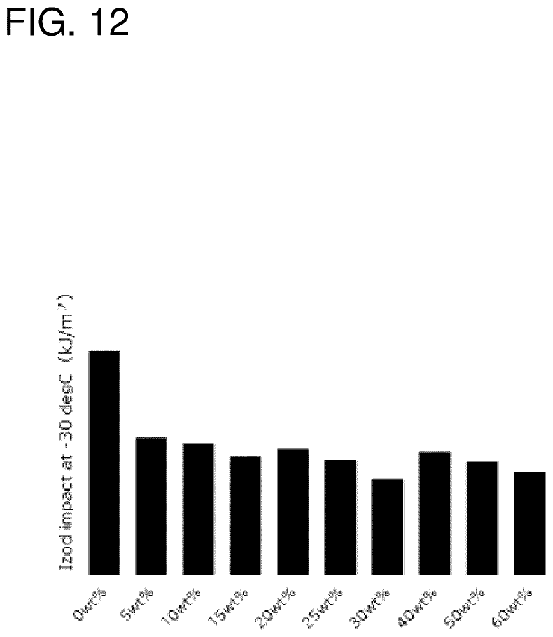

As illustrated in FIG. 5, a density (g/cm³) of the resin molded product 60 increases as the mixing ratio of the recycled material 3 increases. As illustrated in FIG. 6, a heat deflection temperature (° C.) of the resin molded product 60 at a load of 0.45 MPa increases as the mixing ratio of the recycled material 3 increases. As illustrated in FIG. 7, a flexural modulus (MPa) of the resin molded product 60 increases as the mixing ratio of the recycled material 3 increases. As illustrated in FIG. 8, a flexural strength (MPa) of the resin molded product 60 decreases as the mixing ratio of the recycled material 3 increases. As illustrated in FIG. 9, tensile elongation (%) of the resin molded product 60 at break decreases as the mixing ratio of the recycled material 3 increases. As illustrated in FIG. 10, the tensile stress (MPa) of the resin molded product 60 at yield decreases as the mixing ratio of the recycled material 3 increases. As illustrated in FIG. 11 and FIG. 12, Izod impact values (kJ/m²) of the resin molded product 60 both at 23° C. and at −30°C decrease as a result of mixing the recycled material 3.

The mixing ratio of the recycled material 3 (the content ratios of the thermosetting urethane, the short glass fibers, and the PET in the resin molding material 6) is determined in consideration of the required performance of the resin molded product 60 and the above-described properties. For example, a density and a flexural modulus of the resin molded product 60 both increase as the mixing ratio of the recycled material 3 increases (refer to FIG. 5 and FIG. 7). For this reason, when predetermined rigidity (flexural modulus) and weight reduction are required for the resin molded product 60, the recycled material 3 may be mixed at the minimum mixing ratio that achieves the required flexural modulus.

According to the present embodiment, the composite material 1 including the thermosetting urethane is pulverized to produce the recycled material 3. The thus-produced recycled material 3 is mixed with the solid base resin to produce the resin molding material 6. Accordingly, the composite material 1 including the thermosetting urethane can be recycled with the relatively simple equipment, without requiring large-scale equipment such as that used for chemical recycling, and without separating the thermosetting urethane from the composite material 1.

The glass fibers in the composite material 1 are mixed in the resin molding material 6. Thus, the rigidity of the resin molded product 60 produced using the resin molding material 6 is improved. In other words, the strength of the resin molded product 60 can be improved by the glass fibers in the composite material 1.

The recycled material 3 functions also as a bulking material for the resin molding material 6. Thus, a mixed amount of the base resin can be reduced by a mixed amount of the recycled material 3. Accordingly, a used amount of the base resin can be reduced.

The composite material 1 as a waste material can be recycled without being incinerated. Thus, generation of CO₂ can be significantly reduced as compared to the case where the composite material 1 is incinerated.

When the resin molded product 60 becomes a waste material, the resin molded product 60 as the waste material can be pulverized into particles and mixed with the resin molding material 6 so as to be recycled. In this case, the resulting rigidity is somewhat reduced due to the recycling of the resin molded product 60. However, both the glass fibers included in the resin molding material 6 and the glass fibers included in the pulverized resin molded product 60 are short fibers each having a length of approximately 1 mm to 6 mm. For this reason, the resulting rigidity is not significantly reduced, differently from the case where the glass fibers included in the resin molding material 6 are long fibers. In other words, even when the resin molded product 60 is recycled, a reduction in the resulting rigidity can be suppressed as compared to the case where only the resin molding material 6 is used.

### Second Embodiment

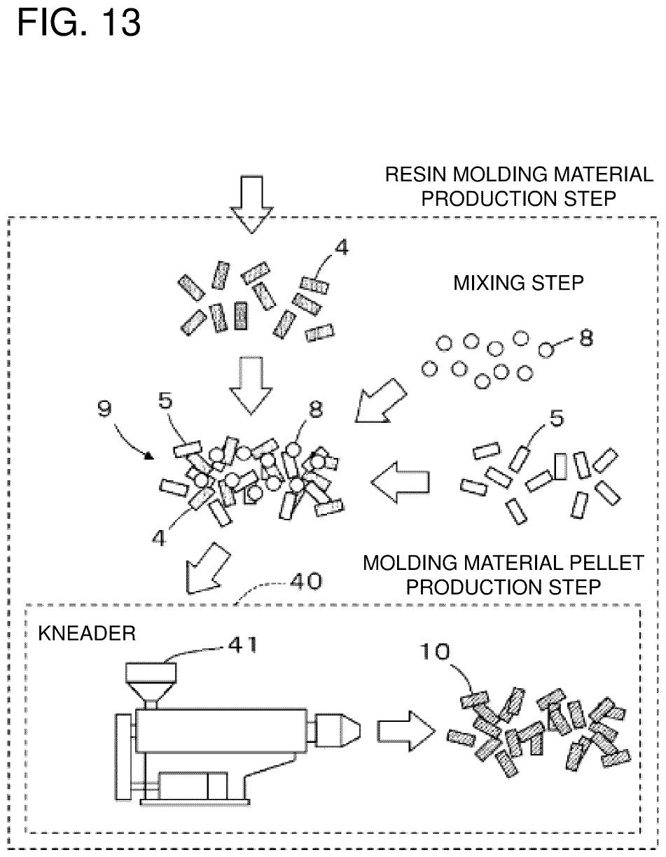

Next, a second embodiment of the present invention is described with reference to FIG. 13. The second embodiment differs from the first embodiment in the mixing step (refer to FIG. 2 and FIG. 13) of the resin molding material production step. The other steps are common to the first and second embodiments. Accordingly, the detailed description of the steps other than the mixing step is omitted in the following.

As illustrated in FIG. 13, at the mixing step in the present embodiment, the recycled material pellets 4 and additives 8 are mixed with the base resin pellets 5 at predetermined mixing ratios to produce the resin molding material 9. At the molding material pellet production step, the resin molding material 9 is fed into the hopper 41 of the kneader 40. Thereby, the recycled material 3 (recycled material pellets 4), the additives 8, and the base resin (base resin pellets 5) are kneaded and compressed into pellets. In this manner, these molding material pellets 10 are produced.

The mixing ratios of the recycled material 3 (recycled material pellets 4), the additives 8, and the base resin (base resin pellets 5) are set such that the recycled material 3 accounts for 5% to 60% by weight, the additives 8 account for 0% to 30% by weight (excluding 0% by weight), and the base resin accounts for 10% to 95% by weight (the total amount of the recycled material 3, the additives 8, and the base resin is 100% by weight).

The additives 8 are added for adjusting the physical property of the resin molded product 60. Examples used as the additives 8 include an inorganic filler such as talc, and a rubber component. Adding the talc as the additives 8 can improve the rigidity of the resin molded product 60. Adding the rubber component as the additives 8 can increase the Izod impact value of the resin molded product 60, and can thus suppress a decrease in the Izod impact value caused by the mixing of the recycled material 3.

The present invention is described above based on the above-described embodiments. The present invention is not limited to the content of the above-described embodiments. Various modifications may, of course, be made as appropriate within the scope of the present invention. In other words, it is natural that other embodiments, examples, operational techniques, and the like made by those skilled in the art based on the above-described embodiments are all included in the scope of the present invention.

For example, in the first embodiment and the second embodiment, the molding material pellet production step (refer to FIG. 2 and FIG. 13) may be omitted. In this case, the resin molded product 60 may be manufactured using the resin molding material 6 or 9 produced at the mixing step, without producing the molding pellets 7 or 10. For example, in the case of the injection molding (refer to FIG. 4), the resin molding material 6 or 9 is fed into the hopper 51 in the injection molding machine 50. Next, in the injection molding machine 50, the resin molding material 6 or 9 is heated and thereby melted, and injected into the mold 52 to be then cooled and solidified. As a result, the resin molded product 60 is formed. The resin molded product 60 is then taken out from the mold 52.

In the first and second embodiments, the recycled material pellet production step (refer to FIG. 1) may be omitted. In this case, at the mixing step of the resin molding material production step (refer to FIG. 2 and FIG. 13), the recycled material 3 in the particle form produced at the pulverization step and the solid base resin are mixed with each other at predetermined mixing ratios, or the recycled material 3 in the particle form, the additives 8, and the solid base resin are mixed with each other at predetermined mixing ratios. Thereby, the resin molding material 6 or 9 is produced.

In the second embodiment, the recycled material pellets 4 and the additives 8 are mixed with the base resin pellets 5 to produce the resin molding material 9. Instead of this, the recycled material pellets 4 and the base resin pellets 5 may be kneaded and compressed similarly to the first embodiment to produce a pellet material (corresponding to the molding material pellets 7 in the first embodiment). Then, the additives 8 may be mixed with the thus-produced pellet material to produce the resin molding material.

### INDUSTRIAL APPLICABILITY

The present invention is applicable to the recycling of a composite material including thermosetting urethane.

### REFERENCE SIGNS LIST

1: Composite material
2: Composite material particle
3: Recycled material
4: Recycled material pellet
5: Base resin pellet
6, 9: Resin molding material
7, 10: Molding material pellet
8: Additive
11: Urethane layer
12: Glass mat layer
13: Film layer
20: Pulverizer
30: Disk-die pelletizer
40: Kneader
41: Hopper
50: Injection molding machine
51: Hopper
52: Mold
60: Resin molded product

What is claimed is:

1. A resin molding material comprising:
(A) a recycled material that is a mixture including thermosetting urethane, short glass fibers, and polyethylene terephthalate; and
(B) a thermoplastic resin;
wherein the recycled material and the thermoplastic resin are mixed with each other such that the recycled material accounts for 5% to 60% by weight and the thermoplastic resin accounts for 40% to 95% by weight, and a total amount of (A) and (B) is 100% by weight.

2. A resin molding material comprising:
(A) a recycled material that is a mixture including thermosetting urethane, short glass fibers, and polyethylene terephthalate;
(B) a thermoplastic resin; and
(C) an additive;
wherein the recycled material and the additive are mixed with the thermoplastic resin such that the recycled material accounts for 5% to 60% by weight, the additive accounts for 0% to 30% by weight (excluding 0% by weight), the thermoplastic resin accounts for 10% to 95% by weight, and a total amount of (A), (B), and (C) is 100% by weight.

3. A method for recycling thermosetting urethane, the method comprising:
a recycled material production step of pulverizing a composite material into particles, wherein the composite material includes the thermosetting urethane, glass fibers, and polyethylene terephthalate, and the pulverizing produces a recycled material that is a mixture including the thermosetting urethane, the glass fibers having been shortened, and the polyethylene terephthalate; and
a resin molding material production step of mixing the recycled material with a thermoplastic resin to produce a resin molding material.
